(19) United States
(12) Patent Application Publication
(10) Pub. No.: US 2009/0279848 A1
(43) Pub. Date: Nov. 12, 2009

(54) REPRODUCING DEVICE AND REPRODUCTION CONTROL METHOD

(75) Inventor: Hiroyuki Taguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/423,180

(22) Filed: Apr. 14, 2009

(30) Foreign Application Priority Data
May 12, 2008 (JP) 2008-124940

(51) Int. Cl. H04N 5/91; H04N 7/26

(52) U.S. Cl. 386/83; 386/124; 386/E05.001

(57) ABSTRACT

When reproduction of any one of contents on any one of mediums is interrupted, a first video device transmits interruption information to a second video device connecting with a network, and the second video device registers the interruption information in an other-device interruption information management table. When given an instruction of reproducing the same content on the same medium, the second video device detects the interruption information of the content from the other-device interruption information management table, and starts reproducing the content from an interrupted position specified by position information contained in the interruption information.

### CROSS-REFERENCE TO RELATED APPLICATIONS

This application is based upon and claims the benefit of prior Japanese Patent Application No. 2008-124940 filed on May 12, 2008, the entire contents of which are incorporated herein by reference.

### FIELD

The embodiments relate to a reproducing device for reproducing a content on a medium, and to a method for controlling the reproduction of the content on the medium.

### BACKGROUND

As broadly known, contents such as a movie, a music clip, a TV drama and a TV animation are stored on mediums exemplified by a DVD [Digital Versatile Disk], a memory card, an iVDR [Information Versatile Disk for Removable usage] cassette and an external HDD [Hard Disk Drive] and are thus distributed. The content stored on the medium is reproduced by a reproducing device into and from which the medium can be inserted and removed.

A conventional reproducing device has a resume function of resuming, when the reproduction of the content is temporarily interrupted and thereafter given an instruction of reproducing the same content, the reproduction of the content from an interrupted position. Accordingly, an operator, when reproducing a content of which the reproduction of the last time has not yet completed to the end, does not take the trouble to search for the interrupted position relying on a memory of the operator himself or herself while pressing a fast-forward button.

If the reproducing device is a small-sized portable device, after viewing halfway the content on the medium in a living room, the medium and the reproducing device are carried together to a bedroom from the living room, and the reproducing device is instructed to reproduce the same content, whereby the continuation of the content can be viewed in the bedroom owing to the resume function of the reproducing device.

In such a case that the reproducing devices are separately installed in the living room and the bedroom, however, the reproducing device in the living room reproduces halfway the content on the medium, then the medium is removed from the reproducing device in the living room and thereafter inserted into the reproducing device in the bedroom, and the reproducing device in the bedroom is instructed to reproduce the same content, in which case the conventional resume function terminates within the single reproducing device with the result that the reproducing device in the bedroom does not resume the reproduction of the same content from the interrupted position.

A known scheme is a scheme that in a system where each of plural clients acquires the content via a network from a content server and reproduces the content, then, when interrupting the reproduction of the content, stores resume information in a self-device, subsequently acquires the resume information from another client when a resume button is pressed, and resumes the reproduction of the content from the interrupted position (for example, Japanese Patent Laid-Open Publication No. 2007-306076). The known scheme does not, however, give a solution enabling one reproducing device to reproduce halfway the content stored on the medium, enabling the medium to be transferred to another reproducing device and enabling another reproducing device to resume the reproduction of a remaining part of the content.

### SUMMARY

According to an aspect to the embodiments, a reproducing device comprises: a reproducing unit reproducing a content on a medium; a generating unit generating, when the reproducing unit receives an instruction from an operator and interrupts reproducing the content, interruption information containing position information for specifying an interrupted position, content information for specifying the content and medium information for specifying the medium stored with the content; a transmitting unit transmitting the interruption information generated by the generating unit to another reproducing device via a network; a recording unit recording, when receiving the interruption information via the network from another reproducing device, the interruption information in a storage device; a search unit searching through the storage device in a way that uses the content information related to the content and the medium information as search conditions when the operator gives the instruction of reproducing any one of the contents on any one of the mediums; and a control unit getting, when the search unit detects the interruption information from the storage device, the reproducing unit to start reproducing the content from the interrupted position specified by the position information contained in the detected interruption information.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram of a configuration of an audio-visual system in a first embodiment.

FIG. 2 is a diagram of a configuration of a first and second video device.

FIG. 3 is a diagram of a configuration of control software stored on a flash memory unit of the first and second video device.

FIG. 4 is a flowchart illustrating a flow of an interruption information registration process.

FIG. 5 is a flowchart illustrating a flow of an interruption information sharing subroutine.

FIG. 6 is a flowchart illustrating a flow of a reception process.

FIG. 7 is a flowchart illustrating a flow of a reproduction start control process.

FIG. 8 is a flowchart illustrating a flow of the other-device interruption information usage subroutine.

FIG. 9 is a flowchart illustrating a flow of an interruption information registering process in a second embodiment.

FIG. 10 is a flowchart illustrating a flow of an other-device interruption information usage subroutine in the second embodiment.

Two examples of an audio-visual system will hereinafter be described by way of embodiments of a disclosed reproducing device with reference to the accompanying drawings.

### First Embodiment

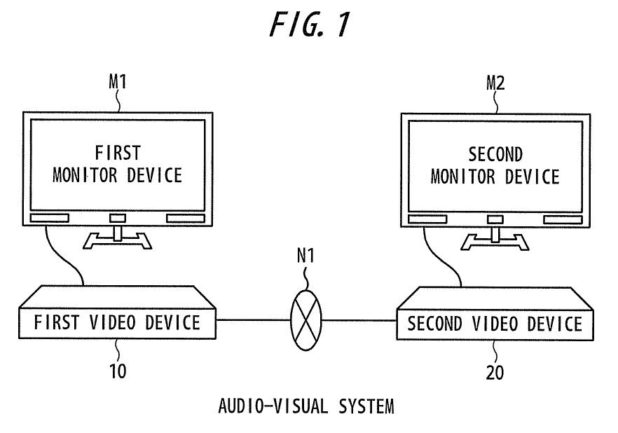

FIG. 1 is a diagram of a configuration of the audio-visual system in a first embodiment.

As illustrated in FIG. 1, the audio-visual system in the first embodiment includes a first video device 10, a first monitor device M1, a second video device 20, and a second monitor device M2. The first monitor device M1 is connected to the first video device 10, and the second monitor device M2 is connected to the second video device 20. Further, the first and second video devices 10, 20 are connected to each other in a communication-enabled status via a network N1.

The first and second video devices 10, 20 are devices which read and reproduce contents such as a movie, a music clip, a TV drama and a TV animation from a medium, and outputs the contents as audio-video signals. Herein, the medium is exemplified by a DVD [Digital Versatile Disk], a memory card, an iVDR [Information Versatile Disk for Removable usage] cassette and an external HDD [Hard Disk Drive] which supports a connection with a USB [Universal Serial Bus]. Specific examples of the first and second video devices 10, 20 are a DVD video recorder, a memory card video recorder, an iVDR cassette video recorder, a TV receiving set with a video record function and a network communication function, and a computer with a multi disc drive, a memory card slot and a video record function. An assumption in the first embodiment is that the first and second video devices 10, 20 are installed in different rooms (e.g., a living room, a parlor, a bedroom, a library, a children's room, a kitchen) of a general type of house. Accordingly, the network N1 in the first embodiment is built up as a home network by a communication cable extending round within the house and a relay device (a computer having a relay function).

Note that the first and second video devices 10, 20 are, as will be described later on, those having essentially the same functions and are separated into the first device and the second device in order to distinguish between a transmitting side and a receiving side of interruption information that will be explained later on for an explanatory reason.

Further, FIG. 1 illustrates only two pieces of video devices, however, three or more video devices may be connected to the network N1 in terms of carrying out the embodiments. Each of the three or more video devices connected to the network N1 can become either the transmitting side or the receiving side of the interruption information that will be described later on.

The first and second monitor devices M1, M2 are devices that output the audio-video data based on the audio-video signals output from the first and second video devices 10, 20. Specific examples of the first and second monitor devices M1, M2 are a TV receiving set and a display device for the computer. The first and second monitor devices M1, M2 are connected to the first and second video devices 10, 20 corresponding thereto in FIG. 1, however, this is because the first and second video devices 10, 20 are installed in the different rooms in the house. If the first and second video devices 10, 20 are installed in the same room, the single monitor device may be used in common to the first and second video devices 10, 20. Moreover, if the video devices 10, 20 are the TV receiving sets with the video record function and the network communication function, the monitor device may be omitted.

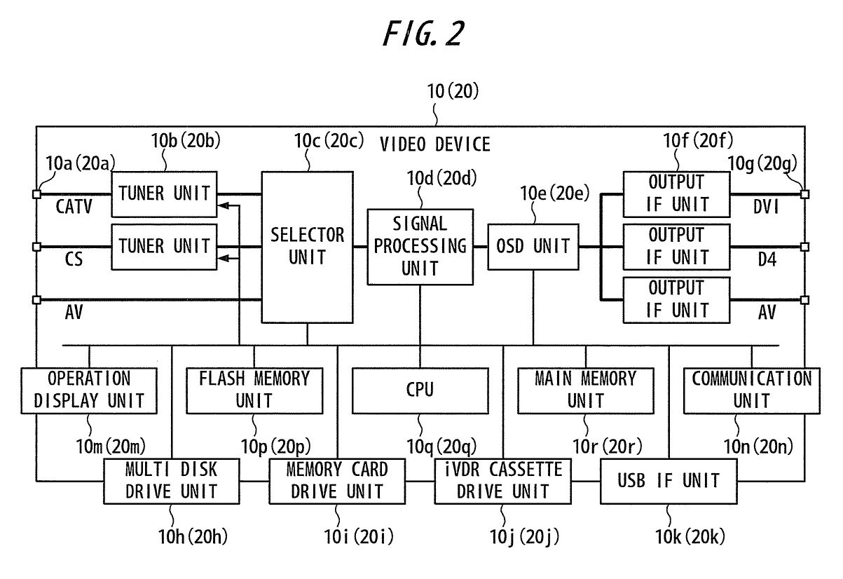

FIG. 2 is a diagram of a configuration of the first video device 10.

As illustrated in FIG. 2, the first video device 10 includes an input terminal unit 10a, a tuner unit 10b, a selector unit 10c, a signal processing unit 10d, an OSD [On Screen Display] unit 10e, an output interface (IF) unit 10f, an output terminal unit 10g, a multi disk drive unit 10h, a memory card drive unit 10i, an iVDR cassette drive unit 10j, a USB interface (IF) unit 10k, an operation display unit 10m, a communication unit 10n, a flash memory unit 10p, a CPU 10q and a main memory unit 10r.

The input terminal unit 10a is a unit for establishing a connection via an antenna line or an audio-video cable to an external device which outputs TV signals or audio-video signals. Specific examples of the external device connected via the antenna line to the input terminal unit 10a are a ground analog antenna, a ground digital antenna, a BS [Broadcast Satellite] analog antenna, a BS digital antenna, a CS [Communication Satellite] digital antenna, a head-end device in a facility of a cable TV broadcaster, and a set-top box connected via a CATV [Community Antenna Television] network to the head-end device. Further, specific examples of the external device connected via the audio-video cable to the input terminal unit 10a are a DVD player, a HDD recorder, a video game machine and a CATV set-top box. The video device 10 in the first embodiment is provided with three pieces of input terminal units 10a, however, the number of the input terminal units 10a may also be equal to or smaller than “2” and equal to or larger than “4”.

The tuner unit 10b is a unit for extracting the TV signals of one channel designated as a viewing-target channel by the CPU 10q, which will be described later on, from within the TV signals of a plurality of channels that are inputted from the input terminal unit 10a, then decompressing (decoding) the compressed data, and outputting the decoded data to the selector unit 10c that will be explained later on. The tuner unit 10b is connected to the input terminal unit 10a of such a type as to be connected to the external device via the antenna line. Note that not the tuner unit 10b but only, e.g., an unillustrated analog/digital conversion unit is interposed between the input terminal unit 10a of such a type as to be connected to the external device via the audio-video cable and the selector unit 10c.

The selector unit 10c is a unit for linking, to the signal processing unit 10d that will hereinafter be explained, the audio-video signals of one route designated by the CPU 10q that will be mentioned later on, from within the plurality of audio-video signals which are inputted from the plurality of input terminal units 10a each serving as one route.

The signal processing unit 10d is a unit which executes a known process about the audio-video signals inputted via one route linked up by the selector unit 10c.

The OSD unit 10e is a unit which executes a process about the video signals inputted from the signal processing unit 10d on the basis of image data when the image data is transferred from the CPU 10q that will be described later on. To be specific, the OSD unit 10e processes the video signals so that an image based on the image data is superimposed on a video based on the video signals output from the signal processing unit 10d.

The output IF unit 10f is a unit which converts the audio-video signals output from the signal processing unit 10d into output signals according to a communications standard corresponding to the output terminal unit 10g connected to the self-unit (the output IF unit 10f). Specific examples of the output signals are a composite video signal, an S-video signal, a component video signal (an output signal of an RCA terminal, output signals of D1-D5 terminals), a DVI [Digital Visual Interface] signal.

The output terminal unit 10g is a unit for establishing the connection via the audio-video cable or a DVI cable to the external device that executes a predetermined process based on the audio-video signals.

The multi disk drive unit 10h is a unit for reading the data from the optical disk such as the DVD and the CD [Compact Disk] and writing the data to the optical disk, and includes, though not illustrated, a mechanism capable of inserting and removing the optical disk. Specific examples based on the standard of the optical disk, which can be handled by the multi disk drive unit 10h according to the first embodiment, are the DVD (including DVD-R [Recordable], DVD-RW [ReWritable], DVD-ROM [Read Only Memory], DVD-RAM [Random Access Memory]), BD [Blue-ray Disc] (including BD-R [Recordable], BD-RE [REwritable], BD-ROM), +R/+WR, CD (including CD-R, CD-RW, CD-ROM).

The memory card drive unit 10i is a unit for reading and writing the data from and to the memory card, and includes, through not illustrated, a mechanism capable of inserting the removing the memory card. Specific examples based on the standard of the memory card, which can be handled by the memory card drive unit 10i according to the first embodiment, are an SD [Secure Digital] card (trademark of Toshiba Co., Ltd., Matsushita Electric Industrial Co., Ltd. and SanDisk Corp. in U.S.A.), Memory Stick (trademark of Sony Corp.), CompactFlash (trademark of SanDisk Corp. in U.S.A.), SmartMedia (trademark of Toshiba Co., Ltd.) and an xD [extreme Digital] picture card (trademark of Fuji Photo Film Cp., Ltd. and Olympus Optical Co., Ltd.)

The iVDR cassette drive unit 10j is a unit for reading and writing the data from and to the iVDR cassette, and includes, through not illustrated, a mechanism capable of inserting and removing the iVDR cassette.

The USB IF unit 10k is a unit for transferring and receiving the data to and from USB-supported device according to the USB standard. In the first embodiment, an external HDD device, which supports the USB connection, can be connected to the USB IF unit 10k.

The operation display unit 10m is a unit for accepting an operation from an operator and displaying items of information such as a route type, a medium type and recording time. The operation display unit 10m includes, though not illustrated, a variety of operation buttons provided on a housing of the video device 10, a sensor which receives an operation signal from a remote controller and a display screen on which the information is displayed.

The communication unit 10n is a unit for transferring and receiving the data to and from the computer connected via the network N1 according to a predetermined communications standard. In the first embodiment, the communication unit 10n of the first video device 10 connects with the second video device 20 via a communication cable and a relay device (a computer having a relay function). A specific example of the communications standard (communications protocol), to which the communication unit 10n is pursuant, is TCP/IP [Transmission Control Protocol/Internet Protocol].

The flash memory unit 10p is a unit on which to record various categories of programs and various items of data for controlling the video device 10. The CPU 10q is a unit which executes a variety of processes based on the program in the flash memory unit 10p. The main memory unit 10r is a unit used for the CPU 10q to cache the programs and the data and develop an operation area.

Note that the first video device 10 and the second video device 20 in the first embodiment have essentially the same functions. Accordingly, the respective units 10a-10k, 10m, 10n and 10p-10r illustrated in FIG. 2 are suffixed with symbols of the respective units 20a-20k, 20m, 20n and 20p-20r of the second video device 20.

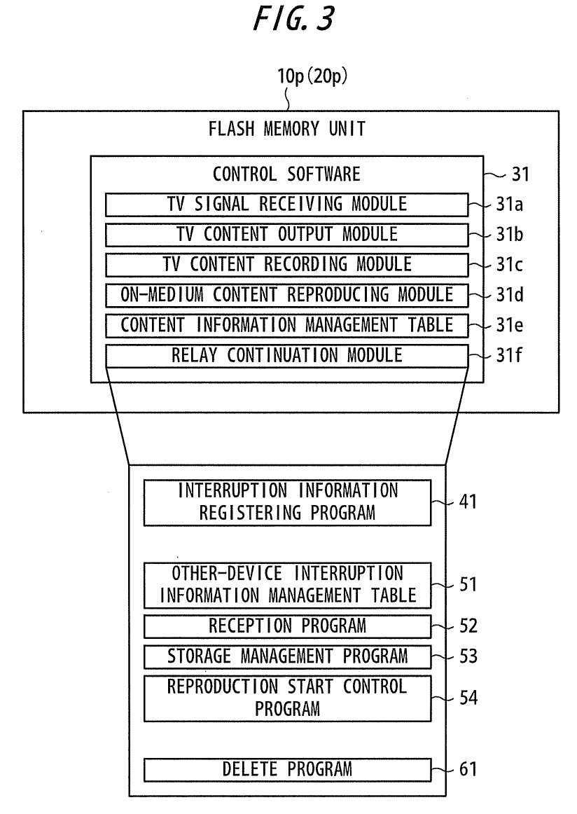

FIG. 3 is a diagram of a configuration of the control software 31 stored on the flash memory unit 10p (20p) of the first (second) video device 10 (20).

The control software 31 includes, as conventional modules, a module 31a for receiving the TV signal, a module 31b for outputting TV content based on the received TV signal, a module 31c for recording the TV content on the medium, and a module 31d for reproducing the content on the medium. Each of these modules 31a-31d is constructed of a program and data for realizing the self-function by controlling the individual units 10a-10k, 10m, 10n, 10p-10r.

Noted that the content reproducing module 31d on the medium corresponds to the reproducing unit described above.

Further, the control software 31 in the first embodiment includes a conventional resume function. The conventional resume function is a function of resuming, when the reproduction of the content is temporarily interrupted and when instructed thereafter to reproduce the same content, the reproduction of the content from the interrupted position. The control software 31 includes a content information management table 31e for realizing the conventional resume function. The content information management table 31e is recorded with the interruption information for every content of which the reproduction remains interrupted. The interruption information contains interruption date/time information for specifying a date/time (year/month/date/hour/minute/second) when the reproduction was interrupted, position information for specifying the interrupted position of the reproduction (hour/minute/second of the time when the reproduction was interrupted), content information (e.g., titles) for specifying the content of which the reproduction was interrupted, and medium information for specifying the medium (types of the optical disk, the memory card, the iVDR cassette, the USB-connection-supported external HDD device, etc) stored with the content. Namely, each of records of the content information management table 31e has a plurality of fields stored with at least the position information, the content information and the medium information.

The control software 31 in the first embodiment further includes a relay continuation module 31f. The relay continuation module 31f includes, as illustrated in FIG. 3, an interruption information registering program 41, an other-device interruption information management table 51, a reception program 52, a storage management program 53, a reproduction start control program 54 and a delete program 61.

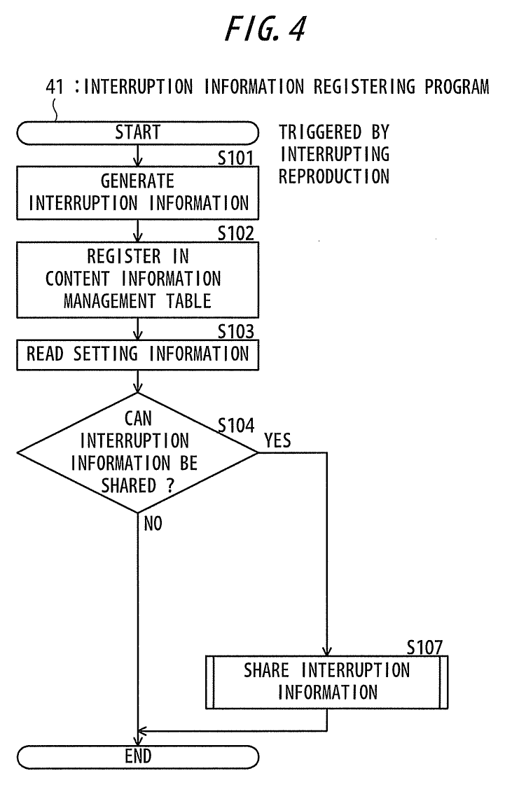

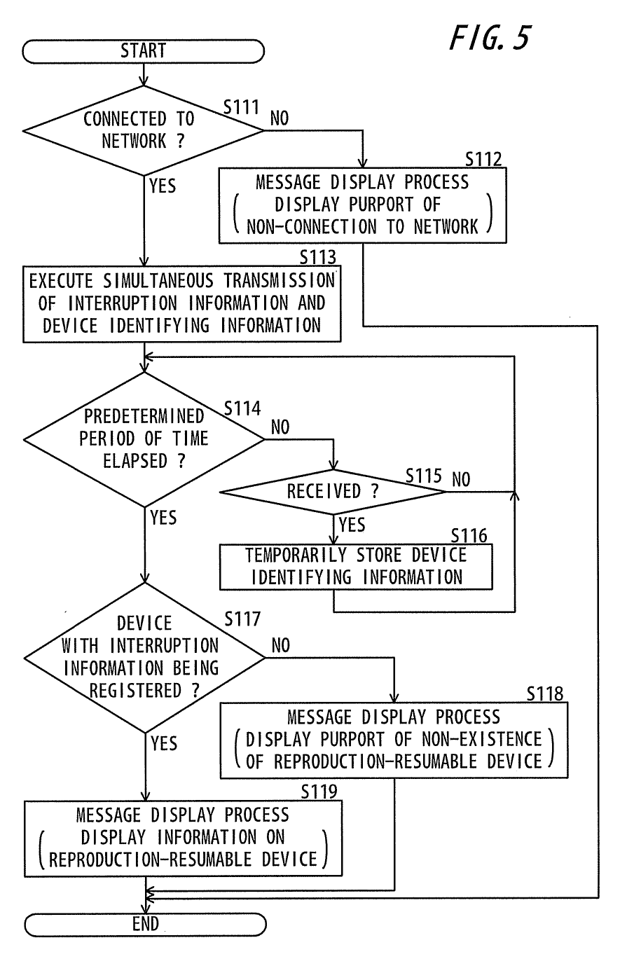

The interruption information registering program 41 is a program for registering the interruption information about the interruption of the reproduction of the content in the self-device (the conventional resume function) and for simultaneously transmitting (broadcasting) the interruption information to other video devices. A start of the interruption information registering program 41 is triggered by an event that the operator instructs the on-medium content reproducing module 31d to interrupt reproducing the content. Thus, the interruption information registering program 41 is the program for realizing the function on the transmitting side of the interruption information. Namely, the interruption information registering program 41 actualizes the function related to the first video device 10. Note that details of the processes executed based on the interruption information registering program 41 by the CPU 10q will be described later on with reference to FIGS. 4 and 5.

The other-device interruption information management table 51 is a table for storing the interruption information transmitted from other video devices. Each of records of the other-device interruption information management table 51 has a plurality of fields stored with the interruption date/time information, the position information, the content information and the medium information that are contained in the interruption information, a field stored with device identifying information (e.g., a combination of a name of a manufacturing maker, a name of a device type and a manufacturing number) for specifying the video device of a sender of the interruption information, and a field stored with registration date/time information for specifying a date/time (year/month/date/hour/minute/second) when the interruption information was registered in the other-device interruption information management table 51.

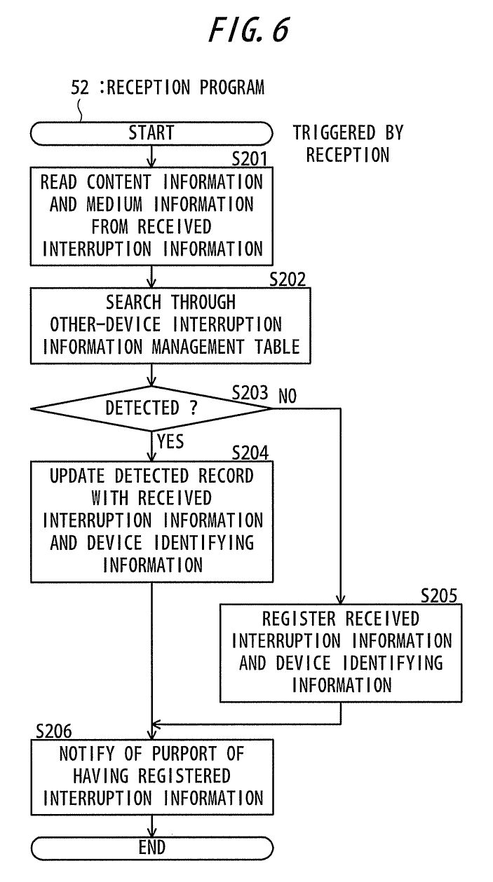

The reception program 52 is a program for registering, in the other-device interruption information management table 51, the interruption information and the device identifying information, which are transmitted by other video devices according to the interruption information registering program 41. A start of the reception program 52 is triggered by receiving the interruption information and the device identifying information from other video devices. Thus, the reception program 52 is the program for realizing the function on the receiving side of the interruption information. Namely, the reception program 52 realizes the function related to the second video device 20. Note that details of the processes executed based on the reception program 52 by the CPU 20q will hereinafter be described with reference to FIG. 6.

The storage management program 53 is a program for deleting the interruption information with an elapse of a predetermined period of time since the registration time from within the other-device interruption information management table 51. The storage management program 53 is periodically started up by the CPU 20q. The CPU 20q, when starting a storage management process by starting up the storage management program 53, searches for the interruption information with the elapse of the predetermined period of time since the registration time and, when detecting the interruption information with the elapse of the predetermined period of time since the registration time, deletes a record of this interruption information from the other-device interruption information management table 51.

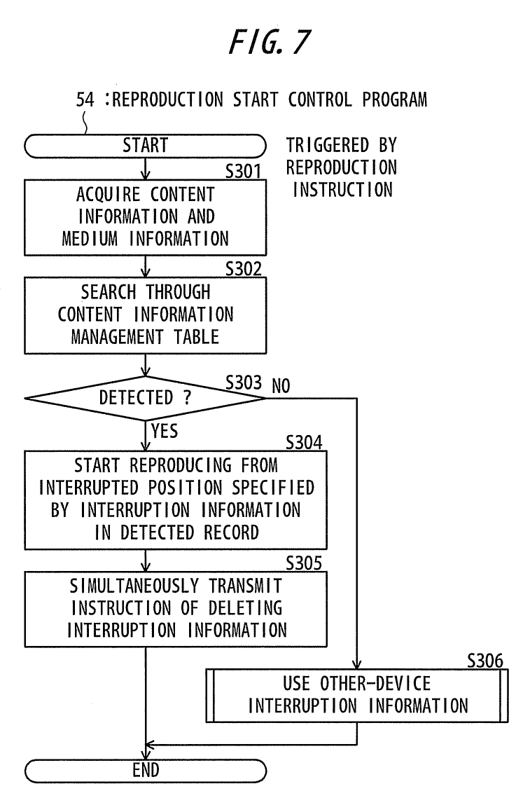

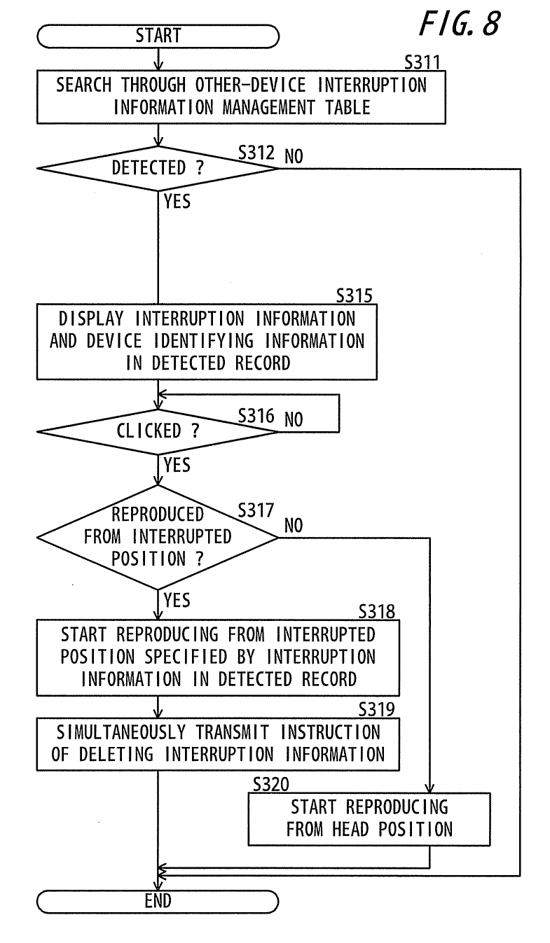

The reproduction start control program 54 is a program for specifying a reproduction start position of the content of which the reproduction is instructed on the basis of the other-device interruption information management table 51, and instructing the on-medium content reproducing module 31d to reproduce the content. A start of the reproduction start control program 54 is triggered by an event that the operator gives an instruction of reproducing any one of the contents on any one of the mediums. Note that details of the processes executed based on the reproduction start control program 54 by the CPU 20q will be described later on with reference to FIGS. 7 and 8.

The delete program 61 is a program for deleting, when instructed by other video devices to delete the interruption information, the record containing the interruption information from the other-device interruption information management table 51.

<<Process>>

Details of the processes executed by the relay continuation module 31f of each of the first video device 10 and the second video device 20, will hereinafter be explained.

<Registration of Interruption Information>

FIG. 4 is a flowchart illustrating a flow of the interruption information registration process executed based on the interruption information registering program 41 by the CPU 10q.

After starting the interruption information registration process, in first step S101, the CPU 10q acquires the information on the interruption of the reproduction of the content from the on-medium content reproducing module 31d, and generates the interruption information based on the acquired information. The interruption information contains, as described above, the position information, the content information and the medium information.

Noted that the CPU 10q executing step S101 corresponds to the generating unit described above.

In next step S102, the CPU 10q registers the interruption information generated in step S101 in the content information management table 31e.

Incidentally, steps S101 and S102 are also the processes based on the conventional resume function.

In next step S103, the CPU 10q reads, from the flash memory unit 10p, setting information for defining whether sharing (the simultaneous transmission of the interruption information to the second video device 20) of the interruption information is permitted or not. Note that the operator has previously determined which option, the permission or the non-permission, of sharing the interruption information with respect to the details of the setting information.

In next step S104, the CPU 10q determines whether or not the setting information read out in step S103 defines the non-permission of the sharing of the interruption information. Then, if the setting information defines the non-permission of the sharing of the interruption information, the CPU 10q terminates the interruption information registration process in FIG. 4. Whereas if the setting information does not define the non-permission of the sharing of the interruption information (i.e., the setting information defines the permission of the sharing of the interruption information), the CPU 10q diverts the processing from step S104 to step S107.

In step S107, the CPU 10q executes an interruption information sharing subroutine.

FIG. 5 is a flowchart illustrating a flow of the interruption information sharing subroutine.

After starting the interruption information sharing subroutine, in first step S111, the CPU 10q determines whether the self-device is connected to the network N1 or not. If the self-device is not connected to the network N1, the CPU 10q diverts the processing from step S111 to step S112.

In step S112, the CPU 10q executes a message display process. In the message display process in step S112, the CPU 10q superimposes, on an output image via an OSD unit 10e, a message screen, on which to describe a purport that the self-device is not connected to the network N1, provided with an OK button. With this superimposition, the message screen is displayed on the first monitor device M1. Then, when the operator clicks the OK button through the operation display unit 10m, the CPU 10q terminates the message display process, then finishes the interruption information sharing subroutine (step S107 in FIG. 4) in FIG. 5, and terminates the interruption information registration process in FIG. 4.

While on the other hand, in step S111, if the self-device is connected to the network N1, the CPU 10q advances the processing to step S113.

In step S113, the CPU 10q simultaneously transmits the interruption information generated in step S101 in FIG. 4 and the device identifying information of the self-device to all of the video devices connecting with the network N1.

Noted that the CPU 10q executing step S113 corresponds to the transmitting unit described above.

In next step S114, the CPU 10q determines whether or not a predetermined period of time elapses since the simultaneous transmission of the interruption information in step S113. Then, if the predetermined period of time does not elapse since the simultaneous transmission of the interruption information, the CPU 10q diverts the processing from step S114 to step S115.

In step S115, the CPU 10q determines which video device of those connecting with the network N1 the notification showing the purport of having registered the interruption information is received from. Then, if the notification showing the purport of having registered the interruption information is received from none of the video devices, the CPU 10q diverts the processing from step S115 and loops back the processing to step S114.

The CPU 10q, when receiving the notification showing the purport of having registered the interruption information from any one of the video devices connecting with the network N1 in the midst of repeatedly executing steps S114 and S115, advances the processing to step S116 from step S115.

In step S116, the CPU 10q temporarily stores, in the main memory unit 10r, the device identifying information contained in the notification received from any one of the video devices in step S115. Thereafter, the CPU 10q loops back the processing to step S114.

Further, the CPU 10q, if the predetermined period of time elapses since the simultaneous transmission of the interruption information in step S113 in the midst of repeatedly executing steps S114 and S115, advances the processing to step S117 from step S114.

In step S117, the CPU 10q determines based on the existence or non-existence of the device identifying information in the main memory unit 10r whether there exists the video device with the interruption information being registered or not. Then, if there is not the video device with the interruption information being registered, the CPU 10q diverts the processing from step S117 to step S118.

In step S118, the CPU 10q executes the message display process. In the message display process in step S118, the CPU 10q superimposes, on the output image via the OSD unit 10e, the message screen, on which to describe a purport that there is not any video device capable of resuming the reproduction of the content, provided with the OK button. With this superimposition, the message screen is displayed on the first monitor device M1. Then, when the operator clicks the OK button through the operation display unit 10m, the CPU 10q terminates the message display process, then finishes the interruption information sharing subroutine (step S107 in FIG. 4) in FIG. 5, and terminates the interruption information registration process in FIG. 4.

While on the other hand, in step S117, if there exists the video device with the interruption information being registered, the CPU 10q advances the processing to step S119.

In step S119, the CPU 10q executes the message display process. In the message display process in step S119, the CPU 10q superimposes, on the output image via the OSD unit 10e, the message screen, on which to describe a purport that there exist the video device capable of resuming the reproduction of the content and information related to the video device, provided with the OK button. Note that the information described on the message screen as the information related to the video device capable of resuming the reproduction of the content, is generated based on the device identifying information temporarily stored in the main memory unit 10r in step S116. With this superimposition, the message screen is displayed on the first monitor device M1. Then, when the operator clicks the OK button through the operation display unit 10m, the CPU 10q terminates the message display process, then finishes the interruption information sharing subroutine (step S107 in FIG. 4) in FIG. 5, and terminates the interruption information registration process in FIG. 4.

Noted that the CPU 10q executing step S119 corresponds to the presenting unit.

<Reception>

FIG. 6 is a flowchart illustrating a flow of a reception process executed by the CPU 20q according to the reception program 52.

After starting the reception process, in first step S201, the CPU 20q reads the content information and the medium information from within the interruption information received from the first video device 10.

In next step S202, the CPU 20q searches through the other-device interruption information management table 51 in a way that uses the content information and the medium information read out in step S202 as search conditions.

In step S203, as a result of the search in step S202, the CPU 20q determines whether any record is detected from the other-device interruption information management table 51 or not. Then, if the record is detected from the other-device interruption information management table 51, the CPU 20q advances the processing to step S204 from step S203.

In step S204, the CPU 20q updates the details (items of information) of the detected record with the interruption information and the device identifying information received from the first video device 10. To be specific, the CPU 20q overwrites the interruption date/time information, the position information, the content information and the medium information contained in the received interruption information to those items of information in the detected record. Further, the CPU 20q overwrites the device identifying information of the first video device 10 defined as the sender of the interruption information to the device identifying information in the detected record, and updates the registration date/time information in the detected record. Thereafter, the CPU 20q advances the processing to step S206.

While on the other hand, as the result of the search in step S202, if any record is not detected from the other-device interruption information management table 51, the CPU 20q diverts the processing from step S203 to step S205.

In step S205, the CPU 20q registers, in the other-device interruption information management table 51, the record containing the interruption information and the device identifying information received from the first video device 10. Herein, the record registered in the other-device interruption information management table 51 contains the interruption date/time information, the position information, the content information and the medium information within the interruption information, the device identifying information of the first video device 10 defined as the sender of the interruption information, and the registration date/time information. Thereafter, the CPU 20q advances the processing to step S206.

In step S206, the CPU 20q transmits the notification showing the purport of having registered the interruption information to the first video device 10. Thereafter, the CPU 20q terminates the reception process in FIG. 6.

Noted that the CPU 20q executing steps S201 through S206 corresponds to the recording unit described above. Further, the CPU 20q executing step S206 corresponds to the notifying unit.

<Reproduction Start Control>

FIG. 7 is a flowchart illustrating a flow of a reproduction start control process executed by the CPU 20q according to the reproduction start control program 54.

After starting the reproduction start control process, in first step S301, the CPU 20q acquires the content information of the content of which the reproduction is instructed by the operator and the medium information of the medium stored with the content.

In next step S302, the CPU 20q searches through the content information management table 31e in a way that uses the content information and the medium information acquired in step S301 as search conditions.

In step S303, as a result of the search in step S302, the CPU 20q determines whether or not any record is detected from the content information management table 31e. Then, if the record is detected from the content information management table 31e, the CPU 20q advances the processing to step S304 from step S303.

In step S304, the CPU 20q reads the position information from within the interruption information in the record detected by the search in step S302, and instructs the on-medium content reproducing module 31d to reproduce the on-medium content from the interrupted position specified by the readout position information. Note that the on-medium content reproducing module 31d, upon receiving this instruction, starts reproducing the on-medium content from the interrupted position.

Noted that steps S301 through S304 are also the processes based on the conventional resume function.

In next step S305, the CPU 20q simultaneously transmits, to other video devices, an instruction of deleting the record containing the same interruption information as the interruption information in the record detected by the search in step S302 from the other-device interruption information management table 51. Note that each of other video devices receiving this instruction deletes the record containing the interruption information from the other-device interruption information management table 51 of the self-device according to the delete program 61 of the self-device. Thereafter, the CPU 20q terminates the reproduction start control process in FIG. 7.

While on the other hand, as a result of the search in step S302, if any record is not detected from the content information management table 31e, the CPU 20q diverts the processing from step S303 to step S306.

In step S306, the CPU 20q executes an other-device interruption information usage subroutine.

FIG. 8 is a flowchart illustrating a flow of the other-device interruption information usage subroutine.

After starting the other-device interruption information usage subroutine, in first step S311, the CPU 20q searches through the other-device interruption information management table 51 in a way that uses the content information and the medium information acquired in step S301 in FIG. 7 as the search conditions.

Noted that the CPU 20q executing step S311 corresponds to the searching unit described above.

In next step S312, as a result of the search in step S311, the CPU 20q determines whether or not any record is detected from the other-device interruption information management table 51. Then, if any record is not detected from the other-device interruption information management table 51, the CPU 20q diverts the processing from step S312, then terminates the other-device interruption information usage subroutine (step S306 in FIG. 7) in FIG. 8, and finishes the reproduction start control process in FIG. 7. Whereas if the record is detected from the other-device interruption information management table 51, the CPU 20q advances the processing to step S315 from step S312.

In step S315, the CPU 20q performs a process of displaying the interruption information and the device identifying information in the detected record. Specifically, the CPU 20q superimposes, on the output image via the OSD unit 10e, the message screen, on which to describe the interruption date/time information, the position information, the content information and the medium information that are contained in the interruption information, the device identifying information and a purport of referring to the permission of the reproduction from the interrupted position, provided with a [YES] button and a [NO] button. With this superimposition, the message screen is displayed on the second monitor device M2.

In next step S316, the CPU 20q stands until the [YES] button or the [NO] button on the message screen displayed on the second monitor device M2 is clicked. Then, when the [YES] button or the [NO] button is clicked, the CPU 20q advances the processing to step S317 from step S316.

In step S317, the CPU 20q determines whether the clicked button is the [YES] button or not. Namely, the CPU 20q determines whether the operator permits the reproduction from the interrupted position or not. Then, if the clicked button is the [YES] button, the CPU 20q advances the processing to step S318 from step S317.

In step S318, the CPU 20q reads the position information from within the interruption information in the record detected by the search in step S311, and instructs the on-medium content reproducing module 31d to reproduce the on-medium content from the interrupted position specified by the readout position information. Note that the on-medium content reproducing module 31d, upon receiving this instruction, starts reproducing the on-medium content from the interrupted position.

Noted that the CPU 20q executing steps S315 through S318 corresponds to the controlling unit described above.

In next step S319, the CPU 20q simultaneously transmits, to other video devices, the instruction of deleting the record containing the same interruption information as the interruption information in the record detected by the search in step S311 from the other-device interruption information management table 51. Note that each of other video devices receiving this instruction deletes the record containing the interruption information from the other-device interruption information management table 51 of the self-device according to the delete program 61 of the self-device. Thereafter, the CPU 20q terminates the other-device interruption information usage subroutine (step S306 in FIG. 7) in FIG. 8, and finishes the reproduction start control process in FIG. 7.

While on the other hand, in step S317, if the clicked button is the [NO] button (namely, if the operator rejects the reproduction from the interrupted position), the CPU 20q advances the processing to step S320.

In step S320, the CPU 20q instructs the on-medium content reproducing module 31d to reproduce the on-medium content from a head position. Note that the on-medium content reproducing module 31d, upon receiving this instruction, starts reproducing the on-medium content from the head position. Thereafter, the CPU 20q terminates the other-device interruption information usage subroutine (step S306 in FIG. 7) in FIG. 8, and finishes the reproduction start control process in FIG. 7.

<<Operational Effect>>

According to the interruption information registering process (FIGS. 4 and 5) and the reception process (FIG. 6) in the first embodiment, when the operator interrupts reproducing any one of the contents in any one of the mediums, the interruption information is transmitted to the second video device 20 connected via the network N1 to the video device (the first video device 10) from the video device serving as the first video device 10 (S101-S103, S104; NO, S107, S111; YES, S113), and it follows that the interruption information is registered in the second video device 20 (S201-S205).

Further, according to the reproduction start control process (FIGS. 7 and 8) in the first embodiment, when the operator of the second video device 20 installs the medium stored with the content of which the reproduction was interrupted by the first video device 10 into the corresponding unit among the respective units 10h-10k of the second video device 20 and gives the instruction of reproducing the on-medium content, the interruption information of this content is detected from the other-device interruption information management table 51 (S301, S302, S303; NO, S306, S311, S312; YES), and it follows that the reproduction of the content is started from the interrupted position specified by the position information of the interruption information (S315, S316, S317; YES, S318).

Hence, the scheme according to the first embodiment is that one video device reproduces halfway the content stored on the medium, the medium is transferred to the other video device, and the other video device can resume the reproduction of the remaining part of the content.

Further, according to the first embodiment, it is inquired of the operator whether or not the reproduction of the content is started from the interrupted position specified by the position information of the interruption information (S315). Therefore, after a first operator has interrupted the reproduction of the on-medium content by the first video device 10, a second operator different from the first operator installs the same medium into the second video device 20 and gives the instruction of reproducing the same content, in which case the second operator can start reproducing the content from the head position (S316, S317; NO, S320).

Further, according to the first embodiment, when the reproduction of the content is started from the interrupted position specified by the position information of the interruption information (S304, S318), the instruction of deleting the record containing the same interruption information from the other-device interruption information management table 51 is simultaneously transmitted to all of the video devices connecting with the network N1 (S305, S319). It therefore does not happen that the once-used interruption information is used by every video device.

Moreover, according to the first embodiment, the CPU 20q of the second video device 20 periodically executes the storage management process based on the storage management program 53, and hence the interruption information registered in the other-device interruption information management table 51 is, when the predetermined period of time elapses since the registration time, deleted from the other-device interruption information management table 51. It therefore does not happen that the old interruption information remains stored in the second video device 20 for any length of time.

### Second Embodiment

A second embodiment is different from the first embodiment in terms of a point that if the medium stored with the content is a medium to which the data is permitted to be written, a process of writing the interruption information related to this content to the same medium is further executed. The processes other than this process in the second embodiment are the same as those in the first embodiment. Further, the hardware configuration (FIGS. 1 and 2) of the second embodiment is the same as that of the first embodiment. The different portion in the second embodiment from the first embodiment will hereinafter be described.

<<Process>>

<Registration of Interruption Information>

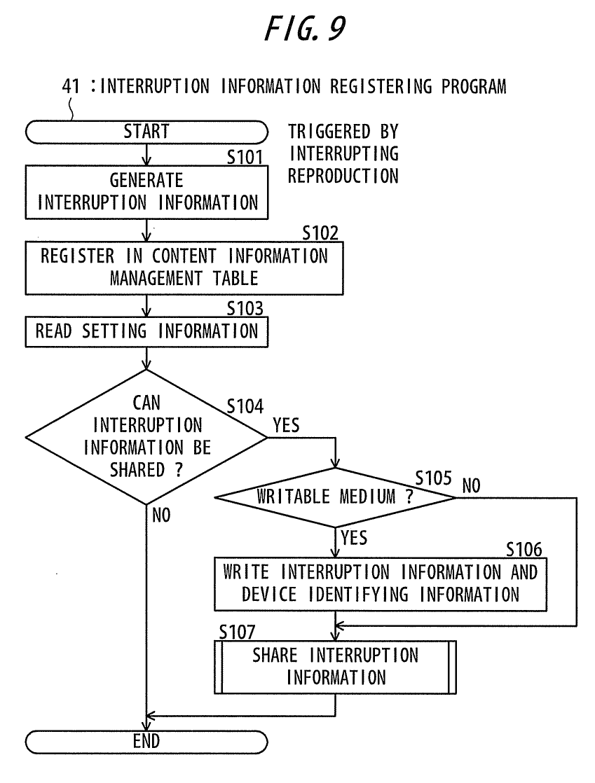

FIG. 9 is a flowchart illustrating a flow of the interruption information registering process executed by the CPU 10q according to the interruption information registering program 41 in the second embodiment.

As obvious from a comparison between FIG. 9 and FIG. 4, in the second embodiment, the CPU 10q determines in step S104 that the setting information in the flash memory unit 10p defines the permission of the sharing and thereafter executes steps S105 and S106 before executing the interruption information sharing subroutine (FIG. 5) in step S107.

In step S105, the CPU 10q determines whether or not the medium stored with the content of which the reproduction was interrupted is the medium to which the data is permitted to be written. Then, if the medium stored with the content of which the reproduction was interrupted is not the medium to which the data is permitted to be written (if the medium is, e.g., an available-on-the-market DVD-ROM stored with a movie as the content), the CPU 10q diverts the processing from step S105 to step S107. Whereas if the medium stored with the content of which the reproduction was interrupted is the medium to which the data is permitted to be written (if the medium is the DVD-RAM on which a TV program broadcasted by a broadcasting station is recorded), the CPU 10q advances the processing to step S106 from step S105.

In step S106, the CPU 10q writes the interruption information generated in step S101 and the device identifying information of the self-device to the medium stored with the content of which the reproduction was interrupted. To be specific, the CPU 10q registers a record containing the interruption information (the interruption date/time information, the position information, the content information, the medium information) and the device identifying information in the table prepared beforehand in the medium. Note that if the interruption information related to the content has already been written to the same medium, the CPU 10q overwrites the interruption information generated in step S101 and the device identifying information of the self-device to the previous interruption information and device identifying information. Thereafter, the CPU 10q advances the processing to step S105.

Noted that the CPU 10q executing steps S105 and S106 corresponds to the writing unit.

<Reproduction Start Control>

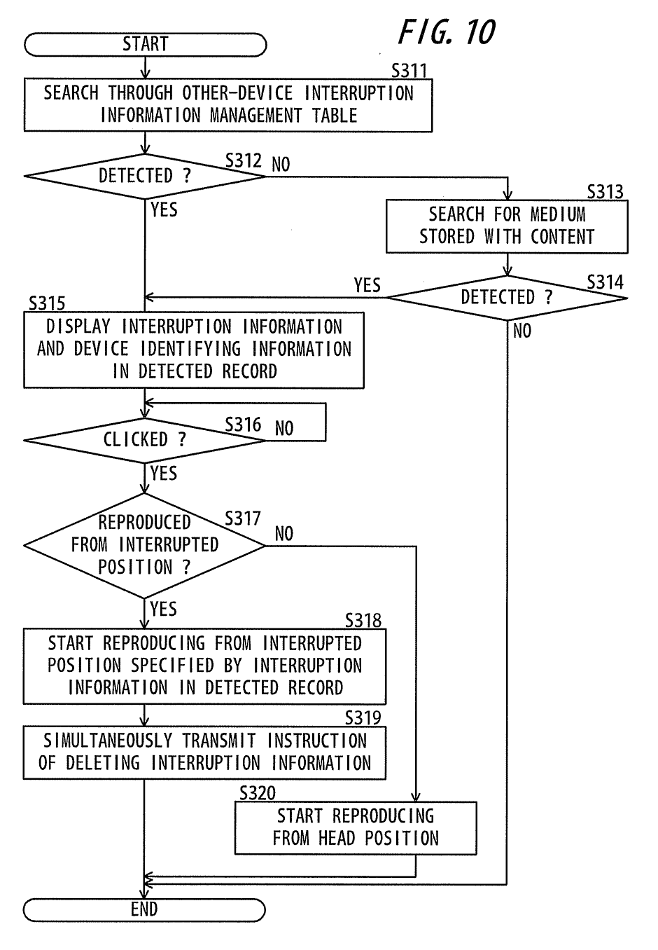

FIG. 10 is a flowchart illustrating a flow of an other-device interruption information usage subroutine (the subroutine executed in step S306 in FIG. 7) in the second embodiment.

As apparent from a comparison between FIG. 10 and FIG. 8, in the second embodiment, the CPU 20q determines in step S312 that a record is detected from the other-device interruption information management table 51, and thereafter executes steps S313 and S314 before executing the process of displaying the interruption information and the device identifying information in the detected record in step S315.

In step S313, the CPU 20q searches through the table in the medium similarly specified by the medium information acquired in step S301 in FIG. 7 in a way that uses the content information acquired in step S301 in FIG. 7 as a search condition.

In next step S314, as a result of the search in step S313, the CPU 20q determines whether or not the record is detected from the table in the medium. Then, if the record is not detected from the table in the medium, the CPU 20q diverts the processing from step S314, then terminates the other-device interruption information usage subroutine (step S306 in FIG. 7) in FIG. 8, and finishes the reproduction start control process in FIG. 7. Whereas if the record is detected from the table in the medium, the CPU 20q advances the processing to step S315 from step S314.

Noted that the CPU 20q executing steps S313 through S318 in FIG. 10 corresponds to the controlling unit.

<<Operational Effect>>

In the interruption information registering process (FIGS. 9 and 5) and the reception process (FIG. 6) in the second embodiment, when the operator of the video device interrupts reproducing any one of the contents in any one of the mediums, the interruption information is transmitted to the second video device 20 connected via the network N1 to the video device (the first video device 10) from the video device serving as the first video device 10 (S101-S103, S104; NO, S107, S111; YES, S113), and it follows that the interruption information is registered in the second video device 20 (S201-S205).

Further, according to the reproduction start control process (FIGS. 7 and 10) in the second embodiment, when the operator of the second video device 20 installs the medium stored with the content of which the reproduction was interrupted by the first video device 10 into the corresponding unit among the respective units 10h-10k of the second video device 20 and gives the instruction of reproducing the on-medium content, the interruption information of this content is detected from the other-device interruption information management table 51 (S301, S302, S303; NO, S306, S311, S312; YES), and it follows that the reproduction of the content is started from the interrupted position specified by the position information of the interruption information (S315, S316, S317; YES, S318).

Hence, the scheme according to the second embodiment is that one video device reproduces halfway the content stored on the medium, the medium is transferred to the other video device, and the other video device can resume the reproduction of the remaining part of the content.

Further, according to the second embodiment, when the operator of the video device interrupts reproducing any one of the contents in any one of the mediums, the interruption information is not only transmitted to the second video device 20 (S107, S111; YES, S113) but also written to the medium (S105; YES, S106).

Then, in a case where the operator of the second video device 20 gives the instruction of reproducing the same content in the medium, if the interruption information of the content is not detected from the other-device interruption information management table 51 (S312; NO), the interruption information of the content is detected from the medium (S313, S314; NO), and it follows that the reproduction of the content is started from the interrupted position specified by the position information of the interruption information (S315, S316, S317; YES, S318).

Therefore, according to the second embodiment, even if the interruption information generated due to the interruption of reproducing the content is registered in none of the second video devices 20 by reason of some cause, and if the medium stored with the content is the medium to which the data is permitted to be written, the reproduction of the same content can be started from the interrupted position by the second video device 20.

Noted that the operation related to the reproducing device can be actualized by a reproduction control program or a reproduction control method. Namely, the embodiments may include the reproduction control program for making a computer function as a plurality of means functioning in the same way as the respective units of the reproducing device described above function, and may also include a reproduction control method by which the computer executes the same functions as those of the respective units by way of a plurality of steps. Further, the embodiments may also include a readable-by-computer medium stored with the reproduction control program.

<<Explanations of Units>>

In the first and second embodiments discussed above, the respective units 10a-10k, 10m, 10n, 10p-10r and 20a-20k, 20m, 20n, 20p-20r of the video devices 10, 20 may each be constructed of a software component and a hardware component and may also be constructed of only the hardware component.

The software component can be exemplified by an interface program, a driver program, a table and data and by a combination of some of these components. These components may be stored on a readable-by-computer medium that will be explained later on and may also be firmware that is fixedly incorporated into a storage device such as a ROM [Read Only Memory] and an LSI [Large Scale Integration].

Moreover, the hardware component can be exemplified by an FPGA [Field Programmable Gate Array], an ASIC [Application Specific Integrated Circuit], a gate array, a combination of logic gates, a signal processing circuit, an analog circuit and other types of circuits. Among these components, the logic gate may include an AND, an OR, a NOT, a NAND, a flip-flop, a counter circuit and so on. Moreover, the signal processing circuit may include circuit elements which execute addition, multiplication, subtraction, inversion, a sum-of-products operation, differentiation and integration of signal values. Further, the analog circuit may include circuit elements which execute amplification, addition, multiplication, differentiation, integration, etc.

Note that the components building up the units 10a-10k, 10m, 10n, 10p-10r, 20a-20k, 20m, 20n, 20p-20r of the video devices 10, 20, are not limited to those exemplified above but may be other components equivalent thereto.

<<Explanation about Software and Program>>

In the first and second embodiments discussed above, the pieces of control software 31, the respective modules 31a-31d, 31f building up the control software 31, the content information management table 31e, the respective programs 41, 52-54, 61 configuring the relay continuation module 31f, the other-device interruption information management table 51 in the flash memory units 10p, 20p of the video devices 10, 20 and the software components described above, may each include a software component, a procedure-oriented language based component, an object-oriented software component, class software, a component managed as a task, a component managed as a process, and elements such as a function, an attribute, a procedure (Procedure), a subroutine (software routine), a fragment or segment of a program code, a driver, firmware, a microcode, a code, a code segment, an extra segment, a stack segment, a program area, a data area, data, a database, a data structure, a field, a record, a table, a matrix table, an array, a variable and a parameter.

Further, the pieces of control software 31, the respective modules 31a-31d, 31f building up the control software 31, the content information management table 31e, the respective programs 41, 52-54, 61 configuring the relay continuation module 31f, the other-device interruption information management table 51 in the flash memory units 10p, 20p of the video devices 10, 20 and the software components described above, may each be described in a C-language, C++, Java (trademark of Sun Microsystems in U.S.A.), Visualbasic (trademark of Microsoft Corp. in U.S.A.), Perl, Ruby and other programming languages.

Moreover, the instruction, the code and the data contained in the pieces of control software 31, the respective modules 31a-31d, 31f building up the control software 31, the content information management table 31e, the respective programs 41, 52-54, 61 configuring the relay continuation module 31f, the other-device interruption information management table 51 in the flash memory units 10p, 20p of the video devices 10, 20 and the software components described above, may be transmitted to or loaded into a computer and a computer incorporated into a machine or a system via a wired network card and a wired network or via a wireless card and a wireless network.

In the transmission or loading described above, the data signals flow via the wired network or the wireless network in the way of their being carried on, e.g., carrier waves. The data signals may also be, however, transferred intact as so-called baseband signals without depending on the carrier waves described above. These carrier waves are transmitted in an electric, magnetic or electromagnetic mode, an optical mode, an acoustic mode or other modes.

Herein, the wired network or the wireless network is a network built up by, e.g., a telephone line, a network line, a cable (including an optical cable and a metallic cable), a wireless link, a mobile phone access line, a PHS [Personal Handyphone System] network, a wireless LAN [Local Area Network], Bluetooth (trademark of the Bluetooth Special Interest Group), on-vehicle type wireless communications (including DSRC [Dedicated Short Range Communication]) and a network constructed of any one of those given above. Then, the data signals are used for transmitting the information including the instruction, the code and the data to a node or a component on the network.

Note that the components configuring the pieces of control software 31, the respective modules 31a-31d, 31f building up the control software 31, the content information management table 31e, the respective programs 41, 52-54, 61 configuring the relay continuation module 31f, the other-device interruption information management table 51 in the flash memory units 10p, 20p of the video devices 10, 20 and the software components described above, are not limited to those exemplified above and may also be other components equivalent thereto.

<<Explanation About Readable-by-Computer Medium>>

Any one of the functions in the first and second embodiments discussed above may be coded and thus stored in a storage area on the readable-by-computer medium. In this case, the program for realizing the function can be provided to the computer or the computer incorporated into the machine or the system via the readable-by-computer medium. The computer or the computer incorporated into the machine or the system reads the program from the storage area on the readable-by-computer medium and executes the program, thereby enabling the function thereof to be realized.

Herein, the readable-by-computer medium connotes a recording medium capable of accumulating information such as the program and the data by electrical, magnetic, optical, chemical, physical or mechanical action, and retaining the information in a readable-by-computer status.

The electrical or magnetic action can be exemplified by writing the data to the element on the ROM [Read Only Memory] constructed by use of a fuse. The magnetic or physical action can be exemplified by a phenomenon of toners to form a latent image on a paper medium. Note that the information recorded on the paper medium can be read, e.g., optically. The optical and chemical action can be exemplified by forming a thin film or a rugged portion on a substrate. Incidentally, the information recorded in the ruggedness-utilized mode can be read, e.g., optically. The chemical action can be exemplified by oxidation-reduction reaction on the substrate or forming an oxide film or a nitride film on a semiconductor substrate, or a photo-resist phenomenon. The physical or mechanical action can be exemplified by forming a rugged portion on an emboss card or forming a punch-hole in the paper medium.

Moreover, in the readable-by-computer mediums, some mediums can be detachably attached to the computer or the computer incorporated into the machine or the system. The attachable/detachable readable-by-computer medium can be exemplified by a DVD (including DVD-R, DVD-RW, DVD-ROM, DVD-RAM), a +R/+RW, a BD (including BD-R, BD-RE, BD-ROM), a CD [Compact Disk] (including CD-R, CD-RW, CD-ROM), an MO [Magneto Optical] disk, other optical disk mediums, a flexible disk (including a floppy disk (Floppy is a trademark of Hitachi Ltd.)), other magnetic disk mediums, a memory card (CompactFlash (trademark of SanDisk Corp. in U.S.A.), SmartMedia (trademark of Toshiba Co., Ltd.), SD card (trademark of SanDisk Corp. in U.S.A., Matsushita Electric Industrial Co., Ltd. and Toshiba Co., Ltd.), Memory Stick (trademark of SonyCorp.), MMC (trademark of Siemens in U.S.A. and SanDisk Corp. in U.S.A.) etc), a magnetic tape and other tape mediums, and a storage device including, as a built-in component, any one of those mediums. Some of the storage devices have a built-in DRAM [Dynamic Random Access Memory] or SRAM [Dynamic Random Access Memory].

Furthermore, some of the readable-by-computer mediums are fixedly installed in the computer or the computer incorporated into the machine or the system. This type of readable-by-computer medium can be exemplified by such as a hard disk, a DRAM, an SRAM, a ROM, an EEPROM [Electronically Erasable and Programmable Read Only Memory] and a flash memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A reproducing device comprising:
a reproducing unit reproducing a content on a medium;
a generating unit generating, when the reproducing unit receives an instruction from an operator and interrupts reproducing the content, interruption information containing position information for specifying an interrupted position, content information for specifying the content and medium information for specifying the medium stored with the content;
a transmitting unit transmitting the interruption information generated by the generating unit to another reproducing device via a network;
a recording unit recording, when receiving the interruption information via the network from another reproducing device, the interruption information in a storage device;
a searching unit searching through the storage device in a way that uses the content information related to the content and the medium information as search conditions when the operator gives the instruction of reproducing any one of the contents on any one of the mediums; and
a controlling unit getting, when the searching unit detects the interruption information from the storage device, the reproducing unit to start reproducing the content from the interrupted position specified by the position information contained in the detected interruption information.

2. The reproducing device according to claim 1, further comprising a writing unit writing, if the medium stored with the content of which the reproduction was interrupted is a medium to which data is permitted to be written, the interruption information generated by the generating unit to the medium,
wherein the controlling unit, if the searching unit is unable to detect the interruption information from the storage device and when the interruption information is written to the medium stored with the content of which the reproduction is instructed, reads the interruption information from the medium and gets the reproducing unit to start reproducing the content from the interrupted position specified by the position information contained in the readout interruption information.

3. The reproducing device according to claim 1, wherein the controlling unit inquires of the operator whether the reproduction from the interrupted position is conducted or not when the searching unit detects the interruption information from the storage device, and gets the reproducing unit to start reproducing the content from the interrupted position specified by the position information contained in the detected interruption information when the operator gives the instruction of making the reproduction from the interrupted position.

4. The reproducing device according to claim 1, further comprising a deleting unit deleting, when a predetermined period of time elapses since the recording unit has recorded the interruption information in the storage device, the interruption information from the storage device.

5. The reproducing device according to claim 1, further comprising:
a notifying unit notifying, when the recording unit records the interruption information in the storage device, an interruption information sender of acceptance; and
a presenting unit presenting, when another reproducing device notifies of acceptance after the transmitting unit has transmitted the interruption information to another reproducing device, information about another reproducing device notifying of the acceptance to the operator.

6. A readable-by-computer medium that stored a reproduction control program for making a computer including a reproducing unit reproducing a content on a medium, execute:
a generating step of generating, when the reproducing unit receives an instruction from an operator and interrupts reproducing the content, interruption information containing position information for specifying an interrupted position, content information for specifying the content and medium information for specifying the medium stored with the content;
a transmitting step transmitting the interruption information generated by the generating step to another computer via a network;
a recording step recording, when receiving the interruption information via the network from another computer, the interruption information in a storage device;
a searching step searching through the storage device in a way that uses the content information related to the content and the medium information as search conditions when the operator gives the instruction of reproducing any one of the contents on any one of the mediums; and
a controlling step getting, when the searching step detects the interruption information from the storage device, the reproducing unit to start reproducing the content from the interrupted position specified by the position information contained in the detected interruption information.

7. The readable-by-computer medium that stored the reproduction control program according to claim 6, further making the computer execute a writing step writing, if the medium stored with the content of which the reproduction was interrupted is a medium to which data is permitted to be written, the interruption information generated by the generating step to the medium,
wherein the controlling step, if the searching step is unable to detect the interruption information from the storage device and when the interruption information is written to the medium stored with the content of which the reproduction is instructed, reads the interruption information from the medium and gets the reproducing unit to start reproducing the content from the interrupted position specified by the position information contained in the readout interruption information.

8. The readable-by-computer medium that stored the reproduction control program according to claim 6, wherein the controlling step inquires of the operator whether the reproduction from the interrupted position is conducted or not when the searching step detects the interruption information from the storage device, and gets the reproducing unit to start reproducing the content from the interrupted position specified by the position information contained in the detected interruption information when the operator gives the instruction of making the reproduction from the interrupted position.

9. The readable-by-computer medium that stored the reproduction control program according to claim 6, further making the computer execute a deleting step deleting, when a predetermined period of time elapses since the recording step has recorded the interruption information in the storage device, the interruption information from the storage device.

10. The readable-by-computer medium that stored the reproduction control program according to claim 6, further making the computer execute:
a notifying step notifying, when the recording step records the interruption information in the storage device, an interruption information sender of acceptance; and
a presenting step presenting, when another computer notifies of acceptance after the transmitting step has transmitted the interruption information to another computer, information about another computer notifying of the acceptance to the operator.

11. A reproduction control method by which a video device including a reproducing unit reproducing a content on a medium, executes:
a generating step of generating, when the reproducing unit receives an instruction from an operator and interrupts reproducing the content, interruption information containing position information for specifying an interrupted position, content information for specifying the content and medium information for specifying the medium stored with the content;
a transmitting step of transmitting the interruption information generated in the generating step to another video device via a network;
a recording step of recording, when receiving the interruption information via the network from another video device, the interruption information in a storage device;
a searching step of searching through the storage device in a way that uses the content information related to the content and the medium information as search conditions when the operator gives the instruction of reproducing any one of the contents on any one of the mediums; and
a controlling step of getting, when the interruption information is detected from the storage device, the reproducing unit to start reproducing the content from the interrupted position specified by the position information contained in the detected interruption information.

12. The reproduction control method according to claim 11, wherein the video device further executes a writing step of writing, if the medium stored with the content of which the reproduction was interrupted is a medium to which data is permitted to be written, the interruption information generated in the generating step to the medium,
wherein the controlling step includes, if the interruption information could not be detected from the storage device in the searching step and when the interruption information is written to the medium stored with the content of which the reproduction is instructed, reading the interruption information from the medium and getting the reproducing unit to start reproducing the content from the interrupted position specified by the position information contained in the readout interruption information.

13. The reproduction control method according to claim 11, wherein the video device in the controlling step inquires of the operator whether the reproduction from the interrupted position is conducted or not when the interruption information is detected from the storage device in the searching step, and gets the reproducing unit to start reproducing the content from the interrupted position specified by the position information contained in the detected interruption information when the operator gives the instruction of making the reproduction from the interrupted position.

14. The reproduction control method according to claim 11, wherein the video device further executes a deleting step of deleting, when a predetermined period of time elapses since the recording step has recorded the interruption information in the storage device, the interruption information from the storage device.

15. The reproduction control method according to claim 11, wherein the video device further executes:
a notifying step of notifying, when recording the interruption information in the storage device in the recording step, an interruption information sender of acceptance; and
a presenting step of presenting, when another video device notifies of acceptance after transmitting the interruption information to another video device in the transmitting step, information about another video device notifying of the acceptance to the operator.
